(19) United States
(12) Patent Application Publication
(10) Pub. No.: US 2021/0010569 A1
(43) Pub. Date: Jan. 14, 2021

(54) AXIALLY PARALLEL HYBRID MODULE WITH CHAIN DRIVE AND TENSIONING SYSTEM

(71) Applicant: Schaeffler Technologies AG & Co. KG, Herzogenaurach (DE)

(72) Inventors: Benjamin Stober, Forstfeld (FR); Steffen Lehmann, Ettlingen (DE); Lionel Huber, Drusenheim (FR)

(73) Assignee: Schaeffler Technologies AG & Co. KG, Herzogenaurach (DE)

(21) Appl. No.: 16/976,637

(22) PCT Filed: Mar. 5, 2019
(86) PCT No.: PCT/DE2019/100196

§ 371 Date: Aug. 28, 2020

(30) Foreign Application Priority Data
Mar. 23, 2018 (DE) 10 2018 106 987.1

(51) Int. Cl. F16H 7/08; F02B 67/06; B60K 6/40

(52) U.S. Cl. CPC F16H 7/08; B60K 6/48; B60K 6/40; F02B 67/06

(57) ABSTRACT

A hybrid module for a drivetrain of a motor vehicle comprises a drive shaft which can be driven by an internal combustion engine and a connecting shaft which can be driven by an electric motor. The shafts can be connected to one another in a torque-transmitting manner by an endless traction means, wherein an eccentric tensioner is used to tension the endless traction means. A drivetrain for a motor vehicle is disclosed with an electric machine and an internal-combustion engine which are connected to one another via a hybrid module.

### CROSS-REFERENCE TO RELATED APPLICATIONS

This application is the U.S. National Phase of PCT Appln. No. PCT/DE2019/100196 filed Mar. 5, 2019, which claims priority to DE 10 2018 106 987.1 filed Mar. 23, 2018, the entire disclosures of which are incorporated by reference herein.

### TECHNICAL FIELD

The present disclosure relates to a hybrid module for a drivetrain of a motor vehicle, such as, for example, a car, a truck or another commercial vehicle, with a drive shaft that can be driven by an internal combustion engine and a connecting shaft that can be driven by an electric motor, which can be connected to one another in a torque-transmitting manner via an endless traction means.

### BACKGROUND

From DE 10 2016 205 019 A1, a hybrid drive parallel to the axis with assembly-optimized bearings and assembly procedures is known. This document describes a hybrid drive with a housing that is fixed to the engine or gearbox and a torque transmission unit that can be supplied with torque from an internal combustion engine and/or an electrical machine, having a belt for transferring torque from the electrical machine to the torque transmission unit, a multi-part carrier fixed to the housing having a first holding part, the outer contour of which, when viewed in the direction of a drive shaft, is arranged between the internal combustion engine and the torque transmission unit within the belt and has a second holding part which is firmly connected to the first holding part and which engages over the belt. Furthermore, an assembly method for the torque-transmitting contacting of a belt with a torque output element and a torque receiving element and for attaching a carrier to an engine or transmission-fixed housing is also described, wherein a first holding part of the carrier is mounted on the torque output element and the torque absorbing element before the belt is attached, and after this belt assembly step, a second holding part of the carrier is fastened to the first holding part, which is fastened to the bearing carrier and/or a housing fixed to the engine or gearbox.

If a chain is used as an endless traction means in such a hybrid drive, it usually must run on a large pitch circle on the axis of rotation of the combustion engine to ensure the translation to the electric machine. The chain is thus heavily loaded in such an application and the speed of rotation in particular is to be regarded as particularly critical. The moments that can be transmitted dynamically are also very high. Due to these loads, elongation and wear of the chain cannot be avoided.

### SUMMARY

The object of the disclosure is therefore to avoid or at least alleviate the disadvantages of the prior art, and in particular to provide a system in which the endless traction means, which is preferably designed as a chain, always has a certain tension during operation, which preferably is constant.

The object of the disclosure is achieved in a generic hybrid module according to the disclosure in that an eccentric tensioner is used to tension the endless traction means.

This can reduce the impact of the endless traction means (such as the chain) and avoid NVH faults. During assembly, it is also advantageous to be able to reduce the distance between the two axes of rotation of the two gear wheels or the pulleys (the electric machine and the combustion engine) so that the endless traction means can be installed cleanly.

Advantageous embodiments are claimed and are explained below.

Thus, it is advantageous if the endless traction means is designed as a chain. A chain can be subjected to higher forces and moments than other endless traction devices, such as a belt. With a chain, higher torques can thus be transmitted from the drive unit(s) to a shaft of a drivetrain.

Furthermore, it has proven to be advantageous if the position of the eccentric tensioner on a hybrid module housing can be fixed in a variable manner, i.e., it can be fixed in different positions on the housing when moving about the eccentric axis of rotation. Thus, the distance between the two axes of rotation of the gear wheels (or the belt pulleys) around which the endless traction means runs can be adjusted to set the tensioning force of the endless traction means individually and as precisely as possible.

For this, it is advantageous if the axis of rotation of the connecting shaft is offset from the axis of rotation of the eccentric tensioner. As a result, when the eccentric tensioner is rotated about the axis of rotation thereof, the distance between the axis of rotation of the connecting shaft and the axis of rotation of the drive shaft is changed.

An advantageous embodiment provides that the eccentric tensioner is divided into a first eccentric component and a second eccentric component separate therefrom, for example along a plane running orthogonal to the axis of rotation of the connecting shaft or the axis of rotation of the eccentric tensioner. Such a division enables a simplified assembly or putting together of the hybrid module.

It is advantageous here if the first eccentric component is screwed onto the second eccentric component. A screw connection is a detachable connection, which also simplifies the disassembly of the eccentric tensioner.

It has proven to be advantageous if the hybrid module housing has at least one elongated hole, preferably two elongated holes, for guiding the relative movement of the eccentric tensioner. The elongated hole or the elongated holes help guide the movement of the eccentric tensioner relative to the housing, and thus simplify the positioning of the eccentric tensioner.

In combination with the elongated holes, it is advantageous here if the eccentric tensioner has at least one adjusting screw, preferably two adjusting screws, for fixing the position on the hybrid module housing. These are inserted through the elongated holes and screwed onto the eccentric tensioner. By tightening or loosening the screws, the position of the eccentric tensioner can either be fixed or changed, the screws being guided in the elongated holes and which thus guides the movement of the eccentric tensioner relative to the housing.

A further advantageous embodiment provides that the connecting shaft has a ring gear which has a larger outer diameter than the connecting shaft and is preferably made in one piece with the connecting shaft. The one-piece design of the ring gear with the connecting shaft increases the stability and thus the transferable forces and moments.

Furthermore, the disclosure also relates to a drivetrain for a motor vehicle with an electric machine and an internal combustion engine, which are connected to one another via a hybrid module according to the disclosure.

In other words, the disclosure consists in the fact that a system has been developed which can adjust the distance between two gear axes of rotation and which ensures the sealing of the system. The system consists of the eccentric principle. In this case, the eccentric tensioner itself is designed in two parts and supports the shaft to the electric machine, such as an electric motor. The motor-side eccentric piece, i.e. the part of the eccentric tensioner which is arranged on the side of the electric machine, is applied and centered on the outer diameter in the motor-side housing part of the hybrid module. At this point, sealing with an O-ring is also provided, which is a known and reliable sealing principle. The eccentric piece on the transmission side, i.e. the part of the eccentric tensioner which is arranged on the transmission side, is screwed onto the eccentric piece on the motor side and determines the axial position of the eccentric tensioner relative to the housing and thereby also the axial position of the (connecting) shaft in the hybrid module. The two pieces of housing are sealed with a flat metal bead foil. The electric machine is screwed onto the eccentric piece on the motor side. The electric machine is also connected by a bracket on the engine block so that the dynamic loads can be transmitted to the electric machine during operation.

The eccentric piece on the motor side also has a bore in the outside area. This bore is used to adjust the eccentric piece and thus to tension the endless traction means, such as the chain, to a certain force after assembly. The eccentric piece is rotated about the seat thereof (i.e., about the axis of rotation thereof) in the housing to increase the distance between the two axes of rotation of the gear wheels.

The eccentric piece on the motor side is also screwed onto the housing, in this case twice. The two screws are installed in elongated holes in the housing to enable the eccentric piece to be adjusted. These screws must be loosened during tensioning. When the specific tension of the screw is reached, the two screws can be screwed in tightly again. It is also planned to check the tensioning force during the auto inspection and, if necessary, to tighten the eccentric again. The tensioning bore and the two adjusting screws are therefore accessible in the vehicle.

It can also be said that, according to the disclosure, a two-part eccentric tensioner is provided in an axially parallel hybrid module. A first part of the eccentric tensioner is adjustably connected to an outside of a housing of an internal combustion engine. An electrical machine is connected to the first part of the eccentric tensioner. A second part of the eccentric tensioner is connected to the first part of the eccentric tensioner. An O-ring is provided between the first part of the eccentric tensioner and the housing of the internal combustion engine. A sealing film is provided between the housing of the internal combustion engine and a housing of a transmission, which receives the second part of the eccentric tensioner.

### BRIEF DESCRIPTION OF THE DRAWINGS

The disclosure is explained in more detail below with the aid of figures in which different embodiments are shown. In the following:

FIG. 1 shows a front view of a hybrid module according to a first embodiment;

FIG. 2 shows the front view from FIG. 1, with a transmission-side housing part of the hybrid module having been removed;

FIG. 3 is a rear view of the hybrid module in the first exemplary embodiment;

FIG. 4 shows a longitudinal sectional view of section IV-IV from FIG. 2, an electric machine and a crankshaft being indicated;

FIG. 5 is an enlarged detail view from the front, to illustrate the eccentric adjustment;

FIG. 6 shows a perspective longitudinal sectional illustration of a partial region of the hybrid module in the region of a connecting shaft; and

FIG. 7 is a perspective sectional view of the hybrid module.

### DETAILED DESCRIPTION

The figures are only schematic in nature and serve only to understand the disclosure. The same elements are provided with the same reference symbols.

Features of the individual exemplary embodiments can also be implemented in other exemplary embodiments. So, they are thus interchangeable with one another.

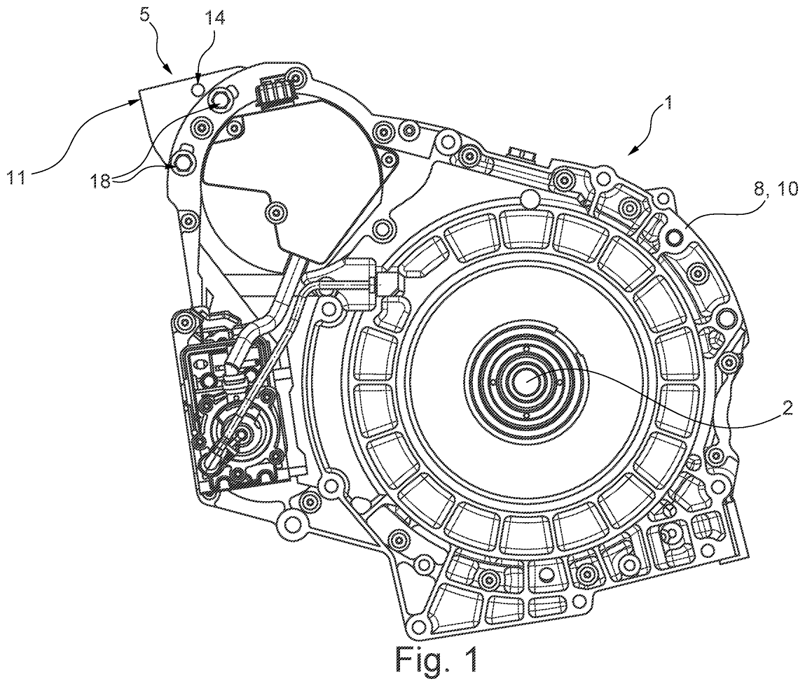

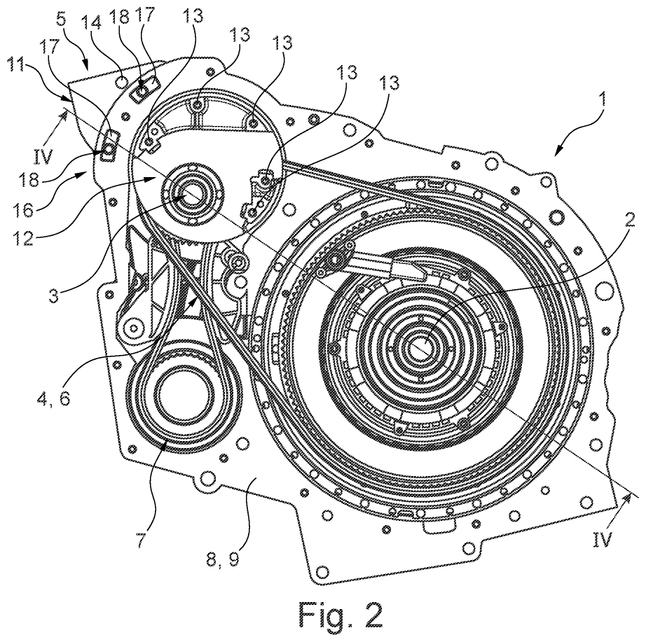

FIG. 1 shows a front view of a hybrid module 1 according to the disclosure. FIG. 2 shows more clearly that in the hybrid module 1, a drive shaft 2 and a connecting shaft 3 are connected in a torque-transmitting manner via an endless traction means 4. An eccentric tensioner 5 is provided to enable a pretensioning of the endless traction means 4. The endless traction means 4 is designed here as a chain 6, for example. This chain drive is also referred to as the main chain drive. A side chain drive 7 can also be seen in FIG. 2. The hybrid module 1 has a hybrid module housing 8, which is formed in two parts. A first hybrid module housing part is referred to as the engine-side hybrid module housing part 9 and a second hybrid module housing part is referred to as the transmission-side hybrid module housing part 10.

The eccentric tensioner 5 is also made in two parts and has a first (motor-side) eccentric component 11 and a second (gear-side) eccentric component 12. The two eccentric components 11, 12 are connected to one another by means of several connecting screws 13.

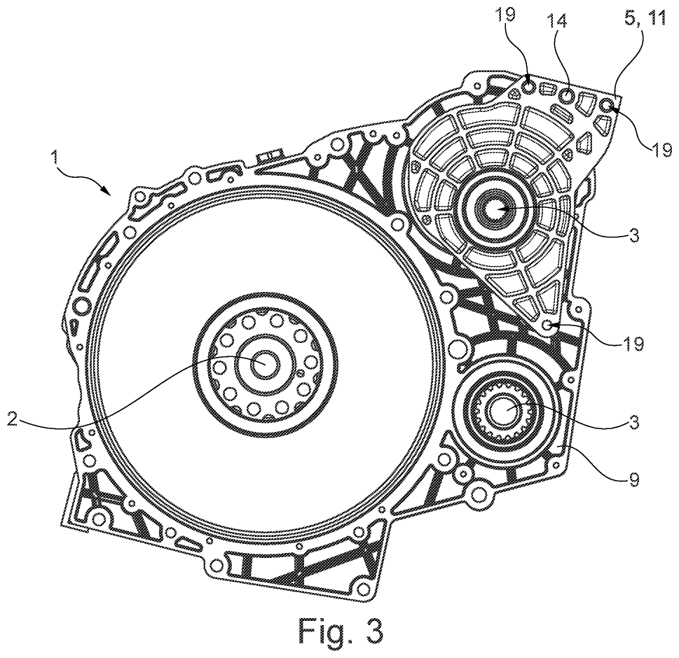

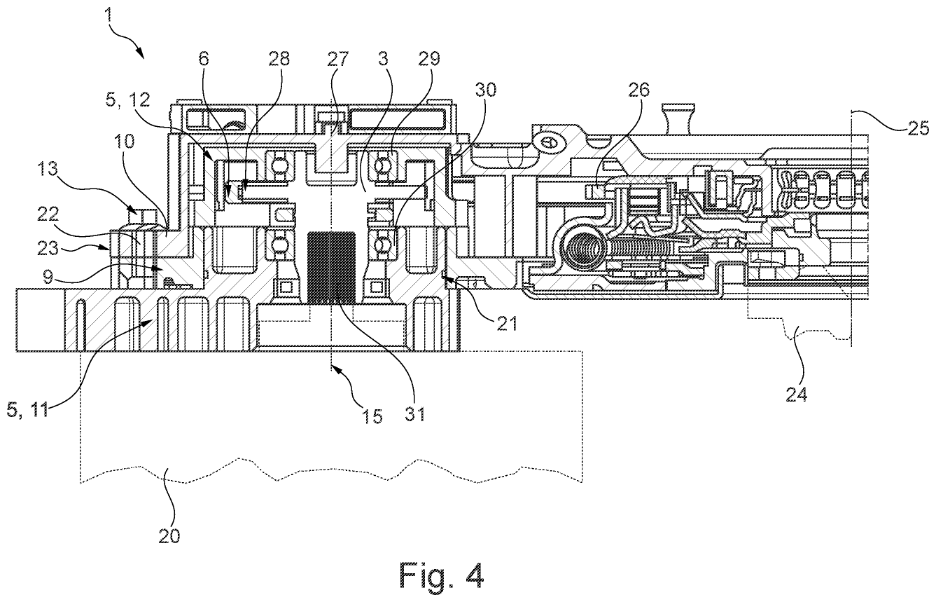

FIG. 3 shows the hybrid module 1 from the opposite side as in FIG. 2. The motor-side hybrid module housing part 9 is also shown here. Here, the shape of the first eccentric-part 11 is also well to recognize. A tightening bore 14 can be seen in both FIG. 2 and FIG. 3. An external component, such as a hook, etc., can be attached to this bore 14 to rotate the eccentric component 11 or the eccentric tensioner 5 about the axis of rotation 15 thereof (see also FIG. 4).

If the desired position of the eccentric component or eccentric tensioner 5 is reached, the eccentric tensioner 5 is fixed relative to the hybrid module housing 8 via an adjustment mechanism 16.

In FIG. 2, the adjustment mechanism 16 is shown in an exemplary embodiment. The adjustment mechanism 16 comprises two elongated holes 17, which are formed in the hybrid module housing 8, and two adjusting screws 18, which are guided in the elongated holes 17 and are screwed onto the eccentric tensioner 5. FIG. 1 shows that the heads of the adjusting screws 18 are larger in diameter than the width of the elongated holes, as a result of which they rest on the hybrid module housing 8.

In FIG. 3 it can also be seen that the eccentric tensioner 5 has a plurality of screw bores 19 which are used to screw onto an electric machine 20 (see also FIG. 4).

FIG. 4 shows a longitudinal sectional view of the hybrid module 1, which illustrates its assembly very clearly. It can be seen that the eccentric tensioner 5 is constructed in two parts, the two parts 11, 12 being screwed together via the connecting screws 13. The motor-side eccentric component 11 is centered on the outer diameter on the motor-side hybrid module housing part 9 and is sealed by an O-ring 21. Further, it can be seen that the two hybrid module housing parts 9, 10 are screwed onto one another via connecting screws 22. The two hybrid module housing parts 9, 10 are sealed by a sealing film 23. FIG. 4 shows the electric machine 20 and a crankshaft 24 of the internal combustion engine (not shown).

The axis of rotation 25 of the internal combustion engine is simultaneously the axis of rotation of a first ring gear 26 on which the chain 6 runs. An axis of rotation 27 of the electric machine 20 is also the axis of rotation of a second ring gear 28. In the exemplary embodiment shown here, the second ring gear 28 is formed in one piece with the connecting shaft 3 and has a smaller diameter than the first ring gear 26. The chain 6 runs both on the first ring gear 26 and on the second ring gear 28 and thus connects the connecting shaft 3 and the drive shaft 2 to one another in a torque-transmitting manner.

The connecting shaft 3 is mounted within the eccentric tensioner 5 via two bearings 29, 30 to be rotatable relative to the eccentric tensioner 5. The axis of rotation 15 of the eccentric tensioner 5 is arranged offset to the axis of rotation 28 of the electric machine 20.

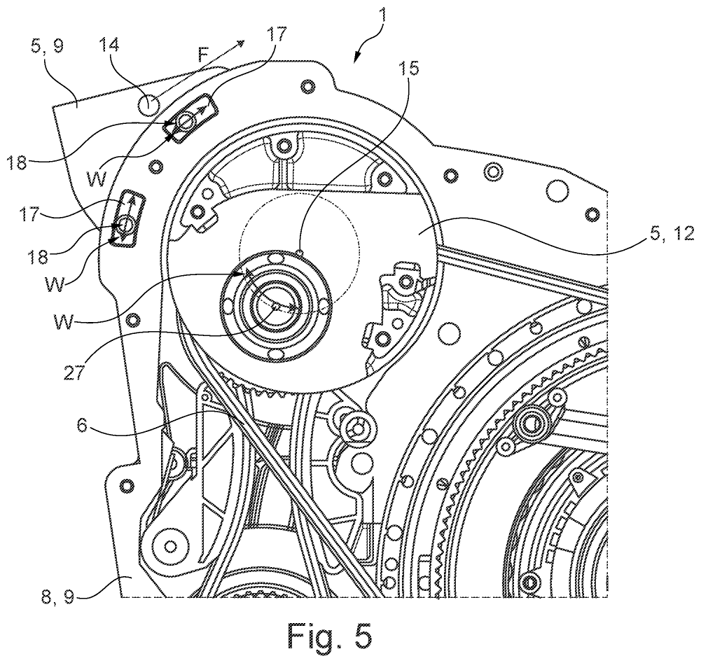

As a result, as illustrated in FIG. 5, it is possible to adjust the distance between the axis of rotation 28 of the electric machine 20 and the axis of rotation 25 of the internal combustion engine by rotating the eccentric tensioner 5 about the axis of rotation 15 thereof. For this purpose, a tensioning force F, which acts in the direction of the arrow shown, is applied in the tightening bore 14 after the adjusting screws 18 have been loosened. The tensioning force F causes the eccentric tensioner 5 to rotate about the axis of rotation 15 thereof, which is indicated by an adjustment path W. The adjustment path W is specified once as a rotation about the axis of rotation 15 and twice as a movement of the adjustment screws 18 through the elongated holes 17. This adjustment path W causes the axis of rotation 27 of the electric machine 20, which is in the position shown here in the so-called zero position (starting position), to be moved out, which causes tension in the chain 6.

With reference back to FIG. 4 it can be seen that the output or output shaft of the electric machine 20 can be connected to the connecting shaft 3 in a torque-transmitting manner via a shaft-hub region 31.

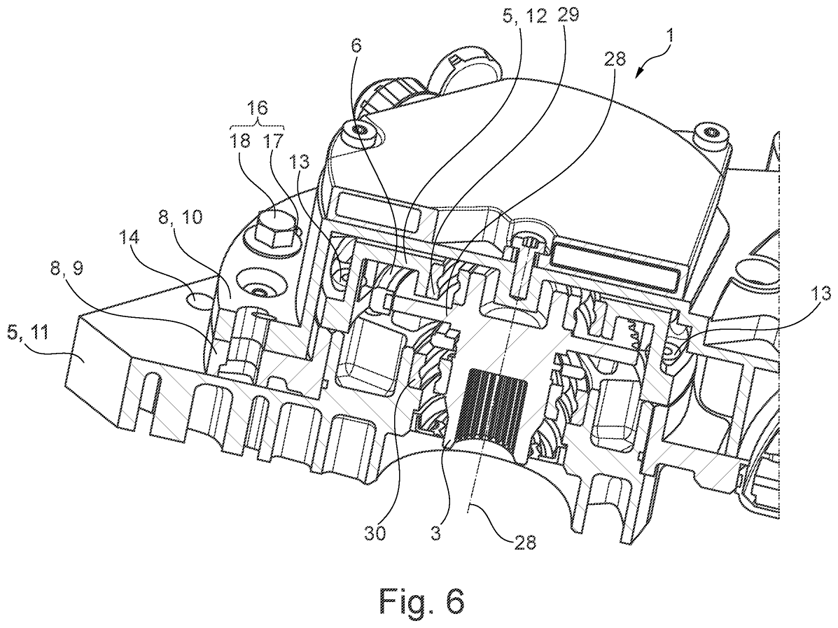

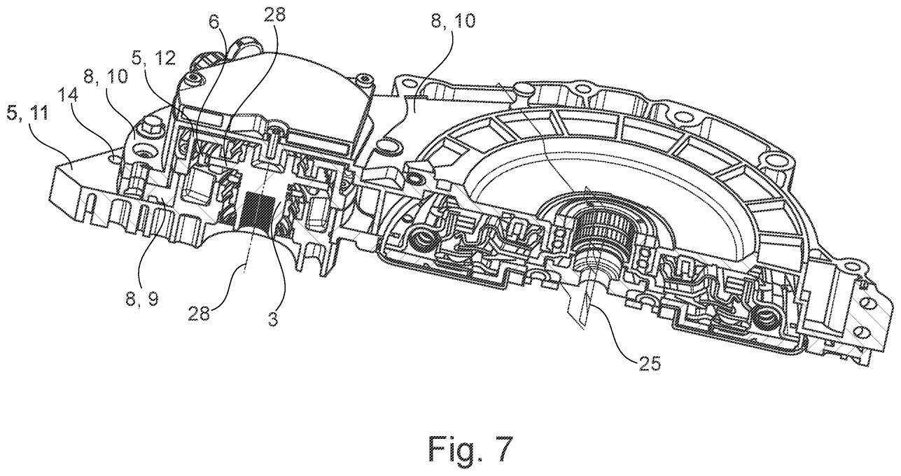

FIGS. 6 and 7 show perspective sectional views, FIG. 7 showing the perspective illustration of the longitudinal sectional view of FIG. 4, and FIG. 6 an enlarged partial view of the perspective sectional view shown in FIG. 7 of the region near the connecting shaft 3 and the eccentric tensioner 5 depicts.

It can be seen here that the eccentric tensioner 5 is received in the hybrid module housing 9 in such a way that it can be rotated relative to the latter, and the position thereof relative to the hybrid module housing 8 can only be fixed via the adjusting mechanism 16.

### LIST OF REFERENCE SYMBOLS

1 Hybrid module

2 Drive Shaft

3 Connecting shaft

4 Endless traction means

5 Eccentric tensioner

6 Chain

7 Side chain drive

8 Hybrid module housing

9 Engine-side hybrid module housing part

10 Transmission-side hybrid module housing part

11 First (motor-side) eccentric component

12 Second (gear-side) eccentric component

13 Connecting screw

14 Tightening hole

15 Eccentric axis of rotation

16 Adjustment mechanism

17 Elongated hole

18 Adjustment screw

19 Screw bore

20 Electric machine

21 O-ring

22 Connecting screw

23 Sealing film

24 Crankshaft

25 Axis of rotation of the internal combustion engine

26 First ring gear

27 Axis of rotation of the electric machine

28 Second ring gear

29 Bearing

30 Bearing

31 Shaft-hub area

F Tensioning force

W Adjustment path

1. A hybrid module for a drivetrain of a motor vehicle, comprising: a drive shaft configured to be driven by an internal combustion engine and a connecting shaft which is configured to be driven by an electric motor, and which is configured to be connected to one another in a torque-transmitting manner by endless traction means, wherein an eccentric tensioner is used for tensioning of the endless traction means.

2. The hybrid module according to claim 1, wherein the endless traction means is designed as a chain.

3. The hybrid module according to claim 1, wherein the eccentric tensioner on a hybrid module housing is configured to be fixed in a position thereof.

4. The hybrid module according to claim 1, wherein an axis of rotation of the connecting shaft is offset from an axis of rotation of the eccentric tensioner.

5. The hybrid module according to claim 1, wherein the eccentric tensioner is divided into a first eccentric component and a separate second eccentric component.

6. The hybrid module according to claim 5, wherein the first eccentric component is screwed onto the second eccentric component.

7. The hybrid module according to claim 3, wherein the hybrid module housing for guiding a relative movement of the eccentric tensioner has at least one elongated hole.

8. The hybrid module according to claim 7, wherein the eccentric tensioner has at least one adjusting screw for fixing a position thereof on the hybrid module housing.

9. The hybrid module according to claim 1, wherein the connecting shaft has a ring gear which has a larger outer diameter than the connecting shaft and is made in one piece with the connecting shaft.

10. A drivetrain for a motor vehicle having an electric machine and an internal combustion engine, which are connected to one another via a hybrid module according to claim 1.
